(19) United States
(12) Patent Application Publication
(10) Pub. No.: US 2018/0101454 A1
(43) Pub. Date: Apr. 12, 2018

(54) MEMORY SYSTEM AND OPERATION METHOD FOR THE SAME

(71) Applicant: SK hynix Inc., Gyeonggi-do (KR)

(72) Inventor: Jong-Min LEE, Seoul (KR)

(21) Appl. No.: 15/605,257

(22) Filed: May 25, 2017

(30) Foreign Application Priority Data
Oct. 10, 2016 (KR) 10-2016-0130551

(51) Int. Cl. G06F 11/20; G06F 3/06

(52) U.S. Cl. CPC G06F 11/2017; G06F 3/0604; G06F 2201/85; G06F 3/0659; G06F 3/0685; G06F 3/064

(57) ABSTRACT

A memory system includes: a non-volatile memory device that includes a plurality of memory blocks each of which includes a plurality of pages; and a controller suitable for programming write data together with corresponding write order information in the plurality of the pages during a write operation, wherein when two or more open blocks are detected among the plurality of the memory blocks during a recovery operation, the controller generates an order table where physical page numbers of the pages of the open blocks are arrayed based on the write order information and determines at least one recovery target page among pages of the open blocks based on the order table.

### CROSS-REFERENCE TO RELATED APPLICATIONS

The present application claims priority of Korean Patent Application No. 10-2016-0130551, filed on Oct. 10, 2016, which is incorporated herein by reference in its entirety.

### BACKGROUND

### 1. Field

Exemplary embodiments of the present invention relate to a memory system, and, more particularly, to a memory system which processes data to and from a memory device, and an operating method thereof.

### 2. Description of the Related Art

The computer environment paradigm has changed to ubiquitous computing systems that can be used anytime and anywhere. Due to this fact, use of portable electronic devices such as mobile phones, digital cameras, and notebook computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption since they have no moving parts. Examples of memory systems having such advantages include universal serial bus (USB) memory devices, memory cards having various interfaces, and solid state drives (SSD).

### SUMMARY

Embodiments of the present invention are directed to a memory system capable of efficiently detecting a recovery target memory region such as a page during a recovery operation after a sudden power-off (SPO), and a method for operating the memory system.

In accordance with an embodiment of the present invention, a memory system may include: a non-volatile memory device that includes a plurality of memory blocks each of which includes a plurality of pages; and a controller suitable for programming write data together with corresponding write order information in the plurality of the pages during a write operation, and when two or more open blocks are detected among the plurality of the memory blocks during a recovery operation, the controller may generate an order table where physical page numbers of the pages of the open blocks are arrayed based on the write order information and may determine at least one recovery target page among pages of the open blocks based on the order table.

The write order information may include values representing a write sequence of the write data programmed in the respective pages. The controller may generate the order table by reading the write order information stored in the pages of the open blocks on a block-by-block basis, and may store in the order table the physical page numbers of the pages of the open blocks according to an ascending value order of the write order information.

The controller may generate the order table by storing in the order table the physical page numbers of the pages of the open blocks corresponding to the write order information that are in a normal state, and may maintain empty a space for the physical page number of the page of the open blocks corresponding to the write order information that are in an erroneous state.

The controller may determine as the at least one recovery target page one or more pages corresponding to the physical page numbers located ahead of the empty space in the order table.

The controller may further determine as invalid pages one or more pages corresponding to the physical page numbers located behind the empty space in the order table.

The controller may generate the order table by storing in the order table logical page numbers corresponding to the physical page numbers to be stored in the order table.

The controller may update map information on the logical page numbers and the physical page numbers based on the order table.

The controller may maintain valid the map information on the physical page numbers and corresponding logical page numbers of the recovery target pages, and may invalidate or may delete the map information on the physical page numbers and corresponding logical page numbers of the invalid pages.

The controller may read first an open block having a page storing the write order information of a smallest value among the open blocks, and may arrange the physical page numbers according to the ascending value order of the write order information when storing the physical page numbers in the order table.

The controller may perform the recovery operation when a power is resumed after a sudden power-off of the memory system.

In accordance with another embodiment of the present invention, a method for operating a memory system provided with a non-volatile memory device including a plurality of memory blocks each of which includes a plurality of pages, the method may include: programming write data together with corresponding write order information in the plurality of the pages during a write operation, and when two or more open blocks are detected among the plurality of the memory blocks during a recovery operation, generating an order table where physical page numbers of the pages of the open blocks are arrayed according to the write order information and determining at least one recovery target page among pages of the open blocks based on the order table. The write order information may include values representing a write sequence of pieces of the write data programmed in the respective pages.

The generating of the order table may include: reading the write order information stored in the pages of the open blocks on a block-by-block basis; and storing in the order table the physical page numbers of the pages of the open blocks according to an ascending value order of the write order information.

The generating of the order table may include: storing in the order table the physical page numbers of the pages of the open blocks corresponding to the write order information that are in a normal state; and maintaining empty a space for the physical page number of the page of the open blocks corresponding to the write order information that are in an erroneous state.

The determining may include determining as the at least one recovery target page one or more pages corresponding to the physical page numbers located ahead of the empty space in the order table.

The determining may further include determining as invalid pages one or more pages corresponding to the physical page numbers located behind the empty space in the order table.

The generating of the order table may include storing in the order table logical page numbers corresponding to the physical page numbers to be stored in the order table.

The method may further include updating map information on the logical page numbers and the physical page numbers based on the order table.

The updating of the map information may include: maintaining valid the map information on the physical page numbers and corresponding logical page numbers of the recovery target pages; and invalidating or deleting the map information on the physical page numbers and corresponding logical page numbers of the invalid pages.

The reading of the write order information may include: reading first an open block having a page storing the write order information of a smallest value among the open blocks; and arranging the physical page numbers according to the ascending value order of the write order information when storing the physical page numbers in the order table.

The method may further include performing the recovery operation when a power is resumed after a sudden power-off of the memory system.

### BRIEF DESCRIPTION OF THE DRAWINGS

These and other features and advantages of the present invention will become apparent to those skilled in the art to which the present invention pertains from the following detailed description in reference to the accompanying drawings, wherein:

FIG. 1 is a block diagram illustrating a data processing system including a memory system, in accordance with an embodiment of the present invention.

FIG. 2 is a schematic diagram illustrating an exemplary configuration of a memory device employed in the memory system of FIG. 1.

FIG. 3 is a circuit diagram illustrating an exemplary configuration of a memory cell array of a memory block in the memory device of FIG. 2.

FIG. 4 is a schematic diagram illustrating an exemplary three-dimensional structure of the memory device of FIG. 2.

FIG. 5 is a block diagram illustrating an operation of a memory system, in accordance with a first embodiment of the present invention.

FIG. 6 is a block diagram illustrating an operation of a memory system, in accordance with a second embodiment of the present invention.

FIGS. 7 to 15 are diagrams schematically illustrating application examples of the data processing system of FIG. 1 in accordance with various embodiments of the present invention.

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, the various embodiments of the present invention will be described in detail with reference to the attached drawings.

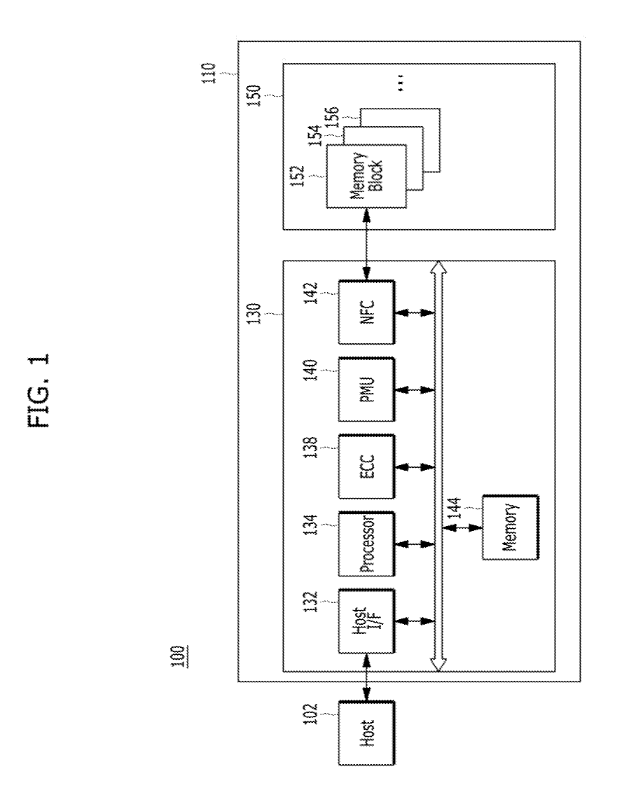

FIG. 1 is a block diagram illustrating a data processing system 100 including a memory system 100 in accordance with an embodiment of the present invention.

Referring to FIG. 1, the data processing system 100 may include a host 102 and the memory system 110.

The host 102 may include portable electronic devices such as a mobile phone, MP3 player and laptop computer or non-portable electronic devices such as a desktop computer, game machine, TV and projector.

The memory system 110 may operate to store data for the host 102 in response to a request of the host 102. Non-limited examples of the memory system 110 may include solid state drive (SSD), multi-media card (MMC), secure digital (SD) card, universal storage bus (USB) device, universal flash storage (UFS) device, compact flash (CF) card, smart media card (SMC), personal computer memory card international association (PCMCIA) card and memory stick. The MMC may include an embedded MMC (eMMC), reduced size MMC (RS-MMC) and micro-MMC, and the SD card may include a mini-SD card and micro-SD card.

The memory system 110 may be embodied by various types of storage devices. Non-limited examples of storage devices included in the memory system 110 may include volatile memory devices such as DRAM dynamic random access memory (DRAM) and static RAM (SRAM) and nonvolatile memory devices such as read only memory (ROM), mask ROM (MROM), programmable ROM (PROM), erasable programmable ROM (EPROM), electrically erasable programmable ROM (EEPROM), ferroelectric RAM (FRAM), phase-change RAM (PRAM), magneto-resistive RAM (MRAM), resistive RAM (RRAM) and flash memory. The flash memory may have a 3-dimensioanl (3D) stack structure.

The memory system 110 may include a memory device 150 and a controller 130. The memory device 150 may store data for the host 120, and the controller 130 may control data storage into the memory device 150.

The controller 130 and the memory device 150 may be integrated into a single semiconductor device, which may be included in the various types of memory systems as exemplified above.

Non-limited application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory dies (not shown), each memory die including a plurality of planes (not shown), each plane including a plurality of memory blocks 152 to 156, each of the memory blocks 152 to 156 may include a plurality of pages, and each of the pages may include a plurality of memory cells coupled to a word line.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) unit 132, a processor 134, an error correction code (ECC) unit 138, a Power Management Unit (PMU) 140, a NAND flash controller (NFC) 142 and a memory 144 all operatively coupled via an internal bus.

The host interface unit 132 may be configured to process a command and data of the host 102, and may communicate with the host 102 through one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI) and integrated drive electronics (IDE).

The ECC unit 138 may detect and correct an error contained in the data read from the memory device 150. In other words, the ECC unit 138 may perform an error correction decoding process to the data read from the memory device 150 through an ECC code used during an ECC encoding process. According to a result of the error correction decoding process, the ECC unit 138 may output a signal, for example, an error correction success/fail signal. When the number of error bits is more than a threshold value of correctable error bits, the ECC unit 138 may not correct the error bits, and may output an error correction fail signal.

The ECC unit 138 may perform error correction through a coded modulation such as Low Density Parity Check (LDPC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC unit 138 is not limited thereto. The ECC unit 138 may include all circuits, modules, systems or devices for error correction.

The PMU 140 may provide and manage power of the controller 130.

The NFC 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the NFC 142 may generate a control signal for the memory device 150 and process data to be provided to the memory device 150 under the control of the processor 134. The NFC 142 may work as an interface (e.g., a NAND flash interface) for processing a command and data between the controller 130 and the memory device 150. Specifically, the NFC 142 may support data transfer between the controller 130 and the memory device 150.

The memory 144 may serve as a working memory of the memory system 110 and the controller 130, and store data for driving the memory system 110 and the controller 130. The controller 130 may control the memory device 150 to perform read, write, program and erase operations in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be embodied by a volatile memory. For example, the memory 144 may be embodied by static random access memory (SRAM) or dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware to control the overall operations of the memory system 110. The firmware may be referred to as flash translation layer (FTL).

The processor 134 of the controller 130 may include a management unit (not illustrated) for performing a bad management operation of the memory device 150. The management unit may perform a bad block management operation of checking a bad block, in which a program fail occurs due to the characteristic of a NAND flash memory during a program operation, among the plurality of memory blocks 152 to 156 included in the memory device 150. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation needs to be performed with more reliability.

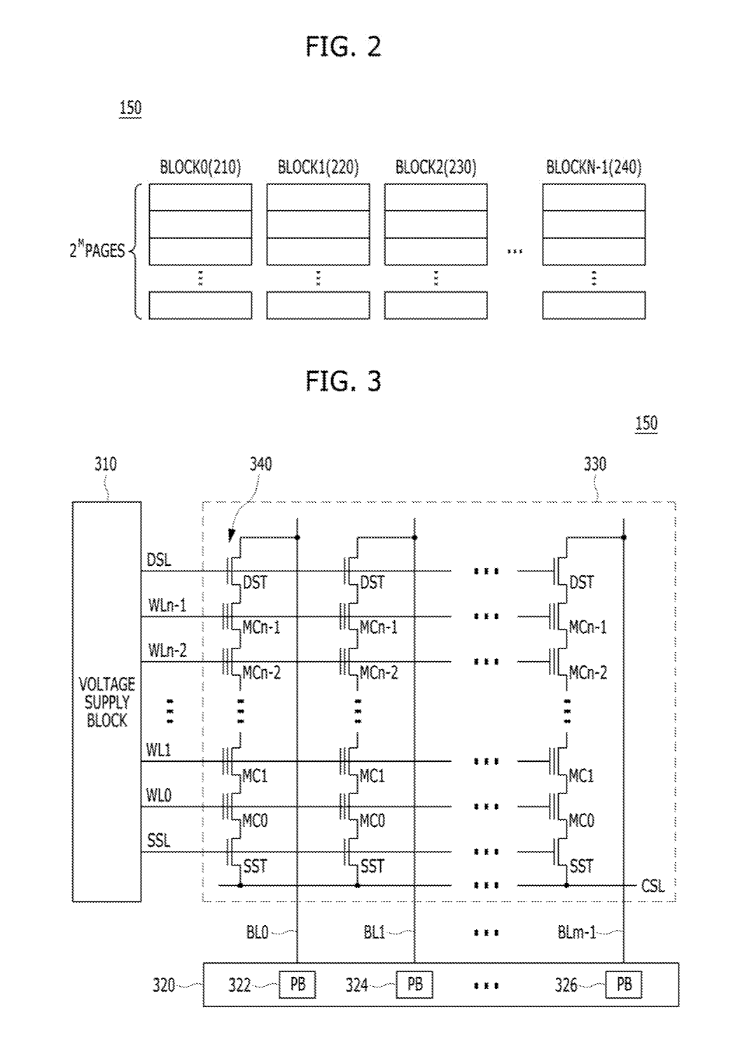

FIG. 2 is a schematic diagram illustrating the memory device 150.

Referring to FIG. 2, the memory device 150 may include a plurality of memory blocks 0 to N−1, and each of the blocks 0 to N−1 may include a plurality of pages, for example, 2^{M} pages, the number of which may vary according to circuit design. Memory cells included in the respective memory blocks 0 to N−1 may be one or more of a single level cell (SLC) storing 1-bit data, a multi-level cell (MLC) storing 2-bit data, a triple level cell (TLC) storing 3-bit data, a quadruple level cell (QLC) storing 4-bit level cell, a multiple level cell storing 5-or-more-bit data, and so forth.

FIG. 3 is a circuit diagram illustrating an exemplary configuration of a memory cell array of a memory block in the memory device 150.

Referring to FIG. 3, a memory block 330 which may correspond to any of the plurality of memory blocks 152 to 156 included in the memory device 150 of the memory system 110 may include a plurality of cell strings 340 coupled to a plurality of corresponding bit lines BL0 to BLm−1. The cell string 340 of each column may include one or more drain select transistors DST and one or more source select transistors SST. Between the select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1.

Although FIG. 3 illustrates NAND flash memory cells, the invention is not limited in this way. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage and a pass voltage to supply to the word lines according to an operation mode. The voltage generation operation of the voltage supply unit 310 may be controlled by a control circuit (not illustrated). Under the control of the control circuit, the voltage supply unit 310 may select one of the memory blocks (or sectors) of the memory cell array, select one of the word lines of the selected memory block, and provide the word line voltages to the selected word line and the unselected word lines.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

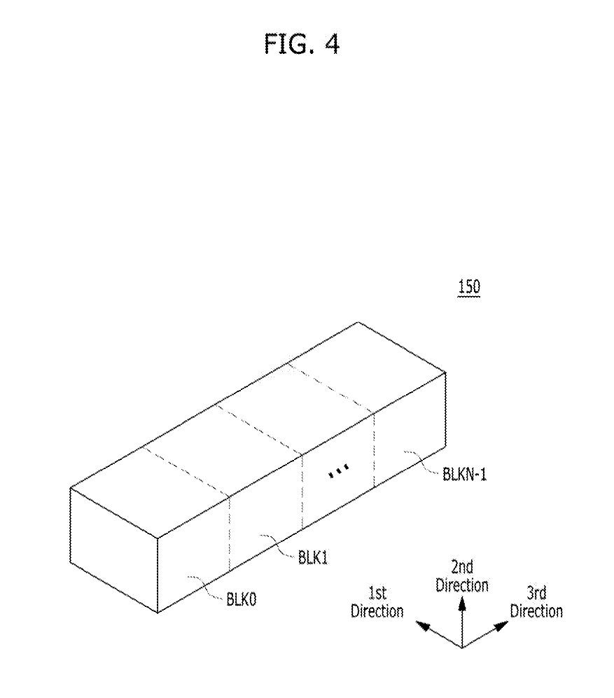

FIG. 4 is a schematic diagram illustrating an exemplary 3D structure of the memory device 150.

The memory device 150 may be embodied by a 2D or 3D memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1 each of the memory blocks having a 3D structure (or vertical structure).

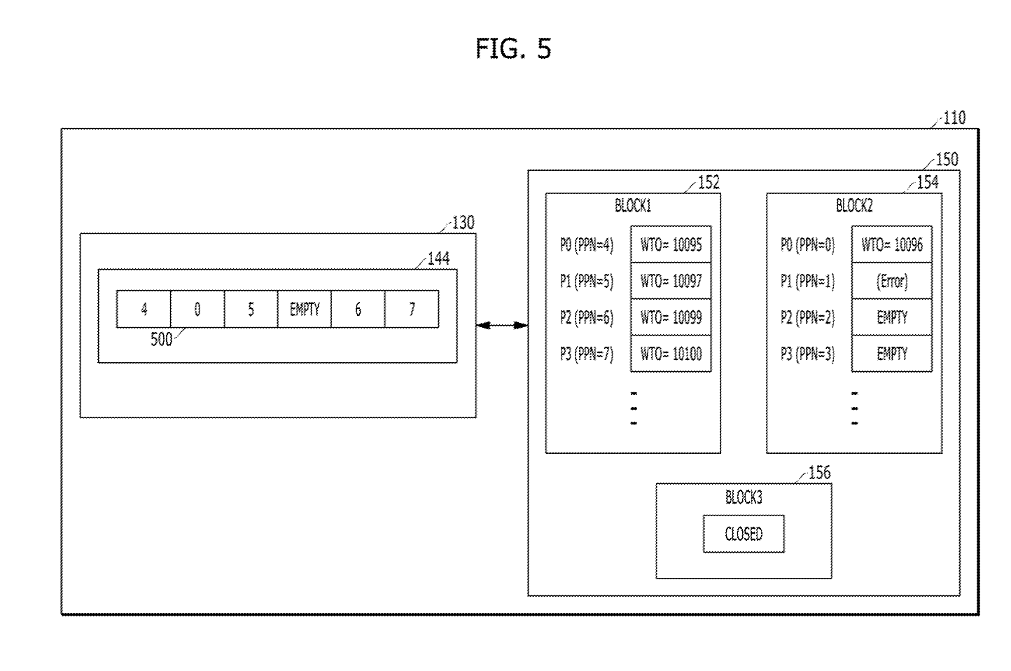

FIG. 5 is a block diagram illustrating an operation of a memory system, in accordance with a first embodiment of the present invention.

Referring to FIG. 5, we note that the structure of the memory system illustrated in FIG. 5 is based on the structure of the memory system illustrated in FIG. 1. However, in FIG. 5 only exemplary configurations of the memory 144 of the controller 130 and the memory blocks 152, 154 and 156 of the memory device 150, are illustrated.

Referring to FIG. 5, each of the memory blocks 152, 154 and 156 may include a plurality of pages P0 to P3. Moreover, it is assumed that, among the memory blocks 152, 154 and 156, the first memory block 152 and the second memory block 154 are open memory blocks including empty pages, and the third memory block 156 is a closed memory block without any empty page.

During a write operation for the non-volatile memory device 150, the controller 130 may store a write order information WTO in each of a plurality of pages P0 to P3 which are included in each of the memory blocks 152, 154 and 156 along with write data (not shown).

For example, FIG. 5 illustrates that the controller 130 may program write data (not shown) alternately in the first memory block 152 and the second memory block 154 in a write operation. For example, a 10095^{th} write data may be programmed in a 0^{th} page P0 of the first memory block 152; a 10096^{th} write data may be programmed in a 0^{th} page P0 of the second memory block 154; a 10097th write data may be programmed in a first page P1 of the first memory block 152; a 10098^{th} write data may be programmed in a first page P1 of the second memory block 154; a 10099^{th} write data may be programmed in a second page P2 of the first memory block 152; and a 10100^{th} write data may be programmed in a third page P3 of the first memory block 152.

The controller 130 may program the write order information WTO together with the write data, when the controller 130 programs the write data (not shown) in the pages of the first and second memory blocks 152 and 154. For example, when the 10095^{th} write data is programmed in the 0^{th} page P0 of the first memory block 152, write order information WTO having a value of 10095 (WTO=10095) is programmed in the 0^{th} page P0 of the first memory block 152, and when the 10096th write data is programmed in the 0^{th} page P0 of the second memory block 154, write order information WTO having a value of 10096 (WTO=10096) is programmed in the 0^{th} page P0 of the second memory block 154. When the 10097^{th} write data is programmed in the first page P1 of the first memory block 152, write order information WTO having a value of 10097 (WTO=10097) is programmed in the first page P1 of the first memory block 152, and when the 10098^{th} write data is programmed in the first page P1 of the second memory block 154, write order information WTO having a value of 10098 (WTO=10098) is programmed in the first page P1 of the second memory block 154. When the 10099^{th} write data is programmed in the second page P2 of the first memory block 152, write order information WTO having a value of 10099 (WTO=10099) is programmed in the second page P2 of the first memory block 152, and when the 10100^{th} write data is programmed in the third page P3 of the first memory block 152, write order information WTO having a value of 10100 (WTO=10100) is programmed in the third page P3 of the first memory block 152.

The write order information WTO is information that represents the order according to which write data are connected when the write data has a value greater than the value of one page and the write data are consecutively programmed in a plurality of pages. For example, in the case of the exemplified write data (not shown), the write data are sequentially programmed in six pages, which are the 0^{th} page P0 of the first memory block 152, the 0^{th} page P0 of the second memory block 154, the first page P1 of the first memory block 152, the first page P1 of the second memory block 154, the second page of the first memory block 152, and the third page P3 of the first memory block 152. Hence, the write order information WTO may represent an order of write data having greater value than a single page and thus having to be programmed into two or more pages. For example, in the above case, the write data are sequentially programmed in six pages (i.e., the 0^{th} page P0 of the first memory block 152 to the third page P3 of the first memory block 152).

While the controller 130 is performing the program operation, a sudden power-off in which power supply to the memory system 110 is cut off abruptly may occur in the middle of the program operation.

The present invention allows when a sudden power-off occurs while write data (not shown) are programmed in the pages P0 to P3 that are included in each of the multiple memory blocks 152, 154 and 156, to detect in which pages the write data were normally programmed and which page was being programmed when the sudden power-off occurred. Hence, the present invention prevents a write error from occurring.

Specifically, when the SPO occurs and then the power supply is resumed, the controller 130 may perform a recovery operation and search for the pages in which the program operation is normally completed among the pages P0 to P3 that are included in each of the multiple memory blocks 152, 154 and 156.

The controller checks whether the write data are normally programmed in the pages P0 to P3, and also checks whether the write data which are programmed normally are in an available state or not.

For example, when it is assumed that there are write data that are consecutively programmed in 6 pages, that the write data are not normally programmed in the page of the fourth order among the 6 consecutive pages, that the write pages are normally programmed in the pages of the first to third orders and the pages of the fifth to sixth orders, then the write data that are programmed in the pages of the fifth to sixth orders following the erroneous page of the fourth order become meaningless data due to the write error occurring in the page of the fourth order. Therefore, if the write data are programmed in 6 consecutive pages, it is necessary to detect in what page the write error occurs.

It is noted, that the write order information WTO represents the continuity of the write data (not shown), and that the write order information WTO has no relation with the order of execution of the write operation. In other words, a write order information WTO having an early number does not signify that the write operation is performed and finished early. Therefore, after a sudden power-off, even though a particular write data which has a high number of write order information WTO is normally programmed, this does not mean that other write data having write order informations WTO of lower numbers are all programmed normally. Hence, the exemplary case described above where the write data are not normally programmed in the page of the fourth order among the 6 consecutive pages and the write pages are normally programmed in the pages of the first to third orders and the pages of the fifth to sixth orders may occur.

The controller 130 in accordance with the first embodiment of the present invention may detect a recovery target page among the pages P0 to P3 by performing the following operation during a recovery operation.

The controller 130 may check out whether there are two or more open blocks among the memory blocks 152, 154 and 156. In other words, the controller 130 may check out whether the write operation is being performed simultaneously to two or more memory blocks among the memory blocks 152, 154 and 156 at a moment when the SPO occurs. Herein, among the memory blocks 152, 154 and 156 that are included in the non-volatile memory device 150, since the closed blocks may not be a target for a write operation at the moment when a sudden power-off occurs, the presence of the closed blocks is out of consideration in the recovery operation section.

For example, in FIG. 5, the first memory block 152 and the second memory block 154 are open blocks and the third block 156 is a closed block among the memory blocks included in the non-volatile memory device 150.

Since there are two or more open blocks, the controller 130 may generate an order table 500 where the physical page numbers PPN of the pages P0 to P3 of each of the open blocks 152 and 154 are arrayed based on the write order information WTO stored in the pages P0 to P3 of each of the open blocks 152 and 154. Herein, since the third memory block 156 is a closed block, the third memory block 156 may not affect the generation of the order table 500. The controller 130 may store and manage the order table 500 in the memory 144 inside the controller 130.

The controller 130 may read the write order information WTO stored in the pages P0 to P3 during the recovery operation.

The controller 130 may read the write order information WTO on a block-by-block basis. In an embodiment, the controller 130 may arbitrarily determine a read sequence of the plurality of open blocks 152 and 154 for reading the write order information WTO. For example, the controller 130 may read the write order information WTO from the open block 152, and then read the write order information WTO from the open block 154. Or as another example, the controller 130 may read the write order information WTO from the open block 154, and then read the write order information WTO from the open block 152. In an embodiment, the controller 130 may determine a read sequence of the plurality of open blocks 152 and 154 for reading the write order information WTO based on the value of the write order information WTO stored in a physically uppermost page in each of the open blocks 152 and 154 when assuming that a write operation is performed to pages physically from top to bottom in a memory block. The controller 130 may determine to read first the write order information WTO in an open block having the smallest one among the values of the write order information WTO stored in the physically uppermost pages in the open blocks 152 and 154. For example, the controller 130 may determine to read the write order information WTO in the open block 152 first among the plurality of open blocks 152 and 154 since the values of the write order information WTO stored in the physically uppermost pages in the open blocks 152 and 154 are 10095 and 10096, respectively, and thus the open block 152 has the smallest value (i.e., 10095) of the write order information WTO.

For example, the value of the write order information WTO is confirmed to be 10095 by reading the 0^{th} page P0 of the first memory block 152; the value of the write order information WTO is confirmed to be 10097 by reading the first page P1 of the first memory block 152; the value of the write order information WTO is confirmed to be 10099 by reading the second page P2 of the first memory block 152; the value of the write order information WTO is confirmed to be 10100 by reading the third page P3 of the first memory block 152; the value of the write order information WTO is confirmed to be 10096 by reading the 0^{th} page P0 of the second memory block 154; an erroneous state may be detected that the write order information WTO is not normally stored by reading the first page P1 of the second memory block 154; and it is confirmed that the second and third pages P2 and P3 of the second memory block 154 are empty pages when assumed that among the 6 consecutive pages the write data are not programmed normally in the page of the fourth order (i.e., the first page P1 of the second memory block 154) while the write data are programmed normally in the pages of the first to third orders and the pages of the fifth to sixth orders at the time of the SPO. Herein, it is assumed that all the pages P0 to P3 of each of the first memory block 152 and the second memory block 154 are in the valid state, and if there is an invalid-state page, the invalid page will be excluded from the targets for the read operation.

Then, the controller 130 may store in the order table 500 the physical page number PPN of each of the pages P0 to P3 of each of the open blocks 152 and 154 corresponding to an ascending order of values of the write order information WTO.

Herein, the controller 130 may store the physical page number PPN of each of the pages P0 to P3 of each of the open blocks 152 and 154 in the order table 500 according to the write order information WTO that is in the normal state among the write order information WTO. Also, the controller 130 may empty a space of the order table 500 corresponding to the write order information WTO that is in an erroneous state among the write order information WTO. FIG. 5 illustrates the empty space as “EMPTY”.

As described above, the controller 130 may read the write order information WTO on the block-by-block basis. In an embodiment, when the controller 130 arbitrarily determines to read the write order information WTO from the first memory block 152 first and then the second memory block 154, or when the controller 130 determines to read the write order information WTO in the open block 152 first and then the second memory block 154 because of the smallest value (i.e., 10095) of the write order information WTO in the open block 152, the order of the write order information WTO becomes 10095→10097→10099→10100→10096→erroneous state.

Therefore, the controller 130 may store ‘4’, which is the physical page number PPN of the 0^{th} page P0 of the first memory block 152 corresponding to the write order information WTO having the value of 10095, which is read firstly, in the first space of the order table 500.

Subsequently, the controller 130 may store ‘5’, which is the physical page number PPN of the first page P1 of the first memory block 152 corresponding to the write order information WTO having the value of 10097, which is read secondly, in the third space of the order table 500. From the values 10095 and 10097 of the previously read and currently read the write order information WTO, the controller 130 may identify a single page, which stores the write order information WTO having a value of 10096. Therefore, the controller 130 may spare a single space for the page of the write order information WTO having a value of 10096 between the first and third spaces corresponding to the values 10095 and 10097 of the previously read and currently read the write order information WTO.

As such, the controller 130 may store in the first, third and fifth spaces of the order table 500 the physical page numbers 4, 5 and 6 of the 0^{th} to second pages P0 to P2 of the first memory block 152, respectively.

From the consecutive values 10099 and 10100 of the previously read and currently read write order information WTO, the controller 130 may store the physical page number 7 of the third page P3 of the first memory block 152, which corresponds to the write order information WTO having a value of 10100, in the sixth space right next to the fifth space of the order table 500, which stores the physical page number 6 and corresponds to the write order information WTO having a value of 10099.

It is noted that since the write order information WTO having the firstly read value of 10095 and the write order information WTO having the secondly read value of 10097 are not consecutive values and there is just not a write order information WTO having a value (which is 10096) between the two values, the controller 130 may store ‘4’, which is the physical page number PPN of the 0^{th} page P0 of the first memory block 152 corresponding to the write order information WTO having the value of 10095, which is read firstly, in the first space of the order table 500, and then store ‘5’, which is the physical page number PPN of the first page P1 of the first memory block 152 corresponding to the write order information WTO having the value of 10097, which is read secondly, in the third space of the order table 500, while maintaining the second space of the order table 500 to be empty space. Subsequently, the controller 130 may store ‘6’, which is the physical page number PPN of the second page P2 of the first memory block 152 corresponding to the write order information WTO having the value of 10099, which is read thirdly, in the fifth space of the order table 500. At this point, since the write order information WTO having the secondly read value of 10097 and the write order information WTO having the thirdly read value of 10099 are not consecutive values and there is just not a write order information WTO having a value (which is 10098) between the two values, the controller 130 may store ‘5’, which is the physical page number PPN of the first page P1 of the first memory block 152 corresponding to the write order information WTO having the value of 10097, which is read secondly, in the third space of the order table 500, and then store ‘6’, which is the physical page number PPN of the second page P2 of the first memory block 152 corresponding to the write order information WTO having the value of 10099, which is read thirdly, in the fifth space of the order table 500, while maintaining the fourth space of the order table 500 to be empty space.

Since it may be seen that the write order information WTO having the value of 10100, which is read fourthly, is a value connected to the write order information WTO having the value of 10099 corresponding to the fifth space of the order table 500, the controller 130 may store ‘7’, which is the physical page number PPN of the third page P3 of the first memory block 152 corresponding to the write order information WTO having the value of 10100 in the sixth space of the order table 500.

Upon completion of the reading of the write order information WTO from the open block 152, the controller 130 may read the write order information WTO from the open block 154. The controller 130 may store ‘0’, which is the physical page number PPN of the 0^{th} page P0 of the second memory block 154 corresponding to the write order information WTO having the value of 10096, which is read fifthly, in the second space of the order table 500. As described above, the second space of the order table 500 is spared for the page of the write order information WTO having the value of 10096 between the first and third spaces corresponding to the values 10095 and 10097 of the write order information WTO.

Since the write order information WTO of the erroneous state is stored in the first page of the second memory block 154, which is read sixthly, the controller 130 may empty the fourth space of the order table 500. As described above, the fourth space of the order table 500 is spared for the page of the write order information WTO having the value of 10098 between the third and fifth spaces corresponding to the values 10097 and 10099 of the write order information WTO. However, since the write order information WTO having the value of 10098 is in an erroneous state at the time of the SPO, the controller 130 may empty the fourth space of the order table 500.

Since the second and third pages P2 and P3 of the second memory block 154 are empty space they are not read.

As described above, the controller 130 may read the write order information WTO from the pages P0 to P3 of the first memory block 152 first, and then the second memory block 154 on the block-by-block basis. Then, the physical page numbers PPN of the pages P0 to P3 of each of the open blocks 152 and 154 may be arrayed according to the ascending value order of the write order information WTO in the order table 500, which is 4→0→5→empty space EMPTY→6→7.

In an embodiment, when the controller 130 reads the second memory block 154 and then the first memory block 152, the order of the write order information WTO is 10096→erroneous state→10095→10097→10099→10100.

Therefore, the controller 130 may store ‘0’, which is the physical page number PPN of the 0^{th} page P0 of the second memory block 154 corresponding to the write order information WTO having the value of 10096, which is read firstly, in the first space of the order table 500.

Since the write order information WTO of the erroneous state is stored in the first page P1 of the second memory block 154, which is read secondly, the controller 130 may not store ‘1’, i.e., the physical page number PPN corresponding to the first page P1 of the second memory block 154, in the order table 500. Since the second and third pages P2 and P3 of the second memory block 154 are empty space, they are not read.

Upon completion of the reading of the write order information WTO from the open block 154, the controller 130 may read the write order information WTO from the open block 152. From the values 10096 and 10095 of the previously read and currently read write order information WTO, the controller 130 may identify that the currently read write order information WTO having the value of 10095 is smaller than the previously read write order information WTO having the value of 10096 which corresponds to the first space of the order table 500. Therefore, the controller 130 may arrange the physical page numbers in the order table 500 according to the ascending order of values of the previously and currently read write order information WTO such that the physical page number PPN of ‘4’, which corresponds to the currently read write order information WTO having the value of 10095, is stored in the first space of the order table 500, and the physical page number PPN of ‘0’, which corresponds to the previously read write order information WTO having the value of 10096, is stored in the second space of the order table 500.

As such, the controller 130 may store in the first to third spaces of the order table 500 the physical page numbers 4, 0 and 5 of the 0^{th} and first pages P0 and P1 of the first memory block 152 and the 0^{th} page of the second memory block 154, respectively.

The controller 130 may store ‘6’, which is the physical page number PPN of the second page P2 of the first memory block 152 corresponding to the write order information WTO having the value of 10099, which is read fifthly, in the fifth space of the order table 500. From the values 10097 and 10099 of the previously read and currently read write order information WTO, the controller 130 may identify a single page, which stores the write order information WTO having a value of 10098. Therefore, the controller 130 may spare a single space for the page of the write order information WTO having a value of 10098 between the third and fifth spaces corresponding to the values 10097 and 10099 of the previously read and currently read write order information WTO.

From the consecutive values 10099 and 10100 of the previously read and currently read write order information WTO, the controller 130 may store the physical page number 7 of the third page P3 of the first memory block 152, which corresponds to the write order information WTO having a value of 10100, in the sixth space right next to the fifth space of the order table 500, which stores the physical page number 6 and corresponds to the write order information WTO having a value of 10099.

As described above, the controller 130 may read the write order information WTO from the pages P0 to P3 of the second memory block 154 first, and then read the write order information WTO of the pages P0 to P3 of the first memory block 152 on the block-by-block basis. Then, the physical page numbers PPN of the pages P0 to P3 of each of the open blocks 152 and 154 may be arrayed according to an ascending order of values of the write order information WTO in the order table 500, which is 4→0→5→empty space EMPTY→6→7.

When the order table 500 is generated as described above, the controller 130 may detect the recovery target pages among the pages P0 to P3 of each of the open blocks 152 and 154 by referring to the order table 500.

To be specific, the controller 130 may check out the physical page numbers PPN stored in the order table 500 in the value order of the write order information WTO and search for the empty space EMPTY. Herein, since the physical page numbers PPN are stored in the order table 500 in the value order of the write order information WTO, the controller 130 may sequentially examine the order table 500 from the first space to the last space one by one to find out whether there is an empty space EMPTY or not. The controller 130 may determine the pages P0 to P3 of the open blocks 152 and 154 corresponding to the physical page numbers PPN that are checked out to be ahead of the empty space EMPTY in the order table 500 as recovery target pages. The controller 130 may determine the pages P0 to P3 of the open blocks 152 and 154 corresponding to the physical page numbers PPN that are checked out to be behind the empty space EMPTY in the order table 500 as invalid pages.

For example, in the above example, the order of 4→0→5→empty space EMPTY→6→7 is stored in the order table 500. Therefore, the controller 130 may determine the pages of the physical page numbers PPN 4, 0 and 5 (i.e., the 0^{th} page P0 of the block 152, 0^{th} page P0 of the block 154 and the first page P1 of the block 152) as the recovery target pages and determine the pages of the physical page numbers 6 and 7 (i.e., the second and third pages P2 and P3 of the block 154) as the invalid pages.

In accordance with the first embodiment of the present invention, the order table 500 may be generated while the pages P0 to P3 included in each of the open blocks 152 and 154 of the memory device 150 are read once on the block-by-block basis, and the recovery target pages may be decided among the pages P0 to P3 included in each of the open blocks 152 and 154 by referring to the generated order table 500. Therefore, the memory system 100 does not have to read a corresponding page by alternately accessing the open blocks 152 and 154 to decide the recovery target pages among the pages P0 to P3 included in each of the open blocks 152 and 154.

Meanwhile, in the first embodiment of the present invention described above, the method of reading the write order informations WTO stored in the pages P0, P1, P2, P3, . . . of the open blocks 152 and 154 included in the memory device 150 in one time, and performing an operation of deciding the value order of the read write order informations WTO by directly comparing the values of the read write order informations WTO with each other during the operation of storing the physical page numbers PPN of the pages P0, P1, P2, P3, . . . of the open blocks 152 and 154 corresponding to the read write order informations WTO in the order table 500 in the value order of the write order information WTO may be used. Also, the following method may be used.

In the first place, the controller 130 may read the write order information WTO stored in one page disposed in the physically uppermost part among the pages P0, P1, P2, P3, . . . included in each of the open blocks 152 and 154 of the memory device 150 and set up the write order information WTO of the smallest value as a basic value (not shown).

For example, the controller 130 may read the write order information WTO stored in the 0^{th} page P0 disposed in the physically uppermost part among the pages P0, P1, P2, P3, . . . included in the first memory block 152 so as to figure out the value of 10095, and read the write order information WTO stored in the 0^{th} page P0 disposed in the physically uppermost part among the pages P0, P1, P2, P3, . . . included in the second memory block 154 so as to figure out the value of 10096. Therefore, the controller 130 may figure out that 10095 is a smaller value between the two read values, which are 10095 and 10096 and thus, the controller 130 may set up the 10095 as the basic value.

After setting up the basic value, the controller 130 may store the physical page numbers PPN of the pages P0, P1, P2, P3, . . . included in each of the open blocks 152 and 154 corresponding to the write order informations WTO in the order table 500 in the value order of the remainders obtained by subtracting the basic value from the values of the write order informations WTO that are read from the pages P0, P1, P2, P3, . . . included in each of the open blocks 152 and 154 of the memory device 150.

For example, the controller 130 may set up the remainder to ‘0’ by subtracting the basic value, which is 10095, from the write order information WTO having the value of 10095 which is read from the 0^{th} page P0 of the first memory block 152; set up the remainder to ‘2’ by subtracting the basic value, which is 10095, from the write order information WTO having the value of 10097 which is read from the first page P1 of the first memory block 152; set up the remainder to ‘4’ by subtracting the basic value, which is 10095, from the write order information WTO having the value of 10099 which is read from the second page P2 of the first memory block 152; set up the remainder to ‘5’ by subtracting the basic value, which is 10095, from the write order information WTO having the value of 10100 which is read from the third page P3 of the first memory block 152; and set up the remainder to ‘1’ by subtracting the basic value, which is 10095, from the write order information WTO having the value of 10096 which is read from the 0^{th} page P0 of the second memory block 154. Herein, since only the write order information WTO of the erroneous state is read from the first page P1 of the second memory block 154, there is no remainder.

Since the remainders may be set up as above, the controller 130 may store the physical page numbers PPN of the pages P0, P1, P2, P3, . . . of each of the open blocks 152 and 154 corresponding to the write order information WTO in the order table 500 in the value order of the remainders. As a result, the physical page numbers PPN stored in the order table 500 may be arrayed in the order of 4→0→5→empty space EMPTY→6→7 as described in the above example. Since the operation process is already described above in detail, further description is not provided herein.

Herein, since the write order information WTO stored in one page disposed in the physically uppermost part is read among the pages P0 to P3 that are included in each of the open blocks 152 and 154 in the process of deciding the basic value described above, the memory system 100 does not have to read one page disposed in the physically uppermost part among the pages P0 to P3 included in each of the open blocks 152 and 154 in the process of deciding the remainders. For example, since the 0^{th} page P0 of the first memory block 152 and the 0^{th} page P0 of the second memory block 154 are read in the process of deciding the basic value, the 0^{th} page P0 of the first memory block 152 and the 0^{th} page P0 of the second memory block 154 are not read in the process of deciding the remainders and only the first to third pages P<1:3> of the first memory block 152 and the first page P1 of the second memory block 154 are read.

Also, in the above-described process of deciding the basic value, the reason why the write order information WTO stored in one page disposed in the physically uppermost part among the pages P0, P1, P2, P3, . . . included in each of the open blocks 152 and 154 in the process of deciding the basic value described above is that it is a general program operation to perform a write operation in a page disposed in the physically upper part and then perform the write operation in a page disposed in the physically lower part. In other words, in one block, the value of the write order information WTO stored in a valid page disposed in the physically uppermost part of the block is generally the smallest value among the values of the write order informations WTO stored in all valid pages included in the block.

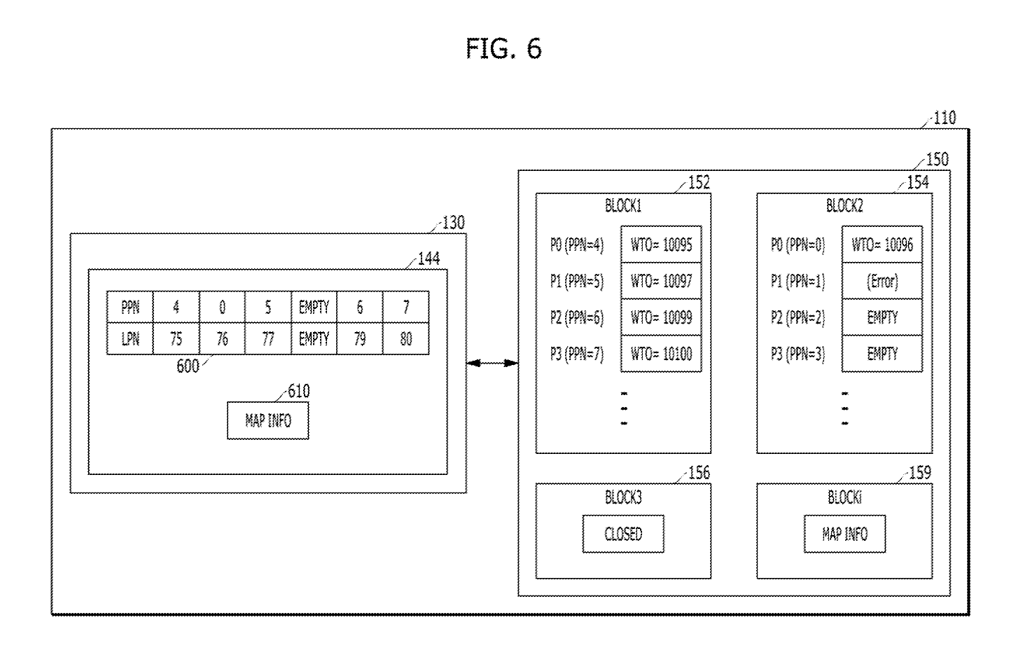

FIG. 6 is a block diagram illustrating an operation of a memory system in accordance with a second embodiment of the present invention.

The second embodiment of FIG. 6 may be the same as the first embodiment of FIG. 5 except that the memory device 150 may further include an i^{th} memory block 159, the memory 144 may further include an internal space 610 and the order table 600 may further store logical page numbers LPNs as well as the physical page numbers PPN of the pages in the memory blocks 152 and 154.

The i^{th} memory block 159 and the internal space 610 may store map information including relationships between the logical page numbers LPN and the physical page numbers PPN of the pages P0 to P3 in the first and second memory blocks 152 and 154. Also, the map information of the i^{th} memory block 159 may be copied to the internal space 610 of the memory 144 for the generation of the order table 600.

The controller 130 may further store the logical page numbers LPN corresponding to the physical page numbers PPN as well as the corresponding physical page numbers PPN in the order table 600.

Further, the controller 130 may update the map information about the logical page numbers LPN and the physical page numbers PPN for the pages P0 to P3 of the open blocks 152 and 154 in the internal space 610 and the i^{th} memory block 159 by referring to the order table 600. In other words, in the internal space 610 and the i^{th} memory block 159, the controller 130 may keep valid the map information about the physical page numbers PPN and the corresponding logical page numbers LPN of the pages determined as the recovery target pages, and may invalidate or delete the map information about the physical page numbers PPN and the corresponding logical page numbers LPN of the pages determined as invalid pages.

Referring to FIG. 6, although not illustrated in FIG. 6, the structure of the memory system illustrated in FIG. 6 is based on the structure of the memory system illustrated in FIG. 1.

Therefore, the operation of the memory system described in FIG. 6 may include controlling the memory device 150 and an operation of a memory 144 included in the controller 130 among the constituent elements of the memory system 110 shown in FIG. 1.

Herein, it is assumed in the embodiment of FIG. 6 that the memory device 150 shown in FIG. 1 is a non-volatile memory device. Therefore, in the following description, the ‘non-volatile memory device’ is given with the same reference numeral as the reference numeral of the memory device 150 shown in FIG. 1. Also, it is assumed in the embodiment of FIG. 6 that the memory 144 included in the controller 130 shown in FIG. 1 is a volatile memory device. Therefore, in the following description, the ‘volatile memory device’ is given with the same reference numeral as the reference numeral of the memory 144 shown in FIG. 1. Also, in the embodiment of FIG. 6, the operation of the memory device 150 is described by representatively including four memory blocks 152, 154, 156 and 159 among the memory blocks 152, 154, 156, . . . that are included in the memory device 150. The constituent elements that appear in FIG. 1 but not appearing in FIG. 6, which include the host interface unit 132, the processor 134, the error correction code (ECC) unit 138, the power management unit (PMU) 140, and the NAND flash controller 142 in the controller 130, are not illustrated in FIG. 6 for the sake of convenience in description but they are included in the controller 130 just as they are included in the controller 130 shown in FIG. 1.

To be specific, the memory system 110 in accordance with the second embodiment of the present invention may include a controller 130 and a non-volatile memory device 150. The controller 130 may include a volatile memory device 144. Also, the non-volatile memory device 150 may include a plurality of memory blocks 152, 154, 156 and 159. Each of the memory blocks 152, 154, 156 and 159 may include a plurality of pages P0 to P3. Among the memory blocks 152, 154, 156 and 159 included in the non-volatile memory device 150, the first memory block 152 and the second memory block 154 are open memory blocks, and the third memory block 156 and an i^{th} memory block 159 are closed memory blocks. In other words, the first memory block 152 and the second memory block 154 are memory blocks including empty pages, which are the pages that are not programmed with write data (not shown), and the third memory block 156 and the i^{th} memory block 159 are memory blocks without a page to be programmed with write data (not shown). Herein, it is assumed that the i^{th} memory block 159 is a memory block storing map information. The i^{th} memory block 159 may be an open block or a closed block. For the sake of convenience in description, it is assumed that the i^{th} memory block 159 is a closed block.

During a write operation for the non-volatile memory device 150, the controller 130 may store a write order information WTO in each of a plurality of pages P0 to P3 that are included in each of the memory blocks 152, 154, 156 and 159 along with write data (not shown).

For example, it may be assumed that the controller 130 programs write data (not shown) in the first memory block 152 and the second memory block 154 in a write operation. In other words, it may be assumed that a 10095^{th} write data is programmed in a 0^{th} page P0 of the first memory block 152; a 10096^{th} write data is programmed in a 0^{th} page P0 of the second memory block 154; a 10097^{th} write data is programmed in a first page P1 of the first memory block 152; a 10098^{th} write data is programmed in a first page P1 of the second memory block 154; a 10099^{th} write data is programmed in a second page P2 of the first memory block 152; and a 10100^{th} write data is programmed in a third page P3 of the first memory block 152.

Based on these assumptions, the controller 130 in accordance with the second embodiment of the present invention may program the write order information WTO, when the controller 130 programs the write data (not shown) in the pages P0 to P3 that are included in each of the first memory block 152 and the second memory block 154. In short, when the 10095^{th} write data is programmed in the 0^{th} page P0 of the first memory block 152, write order information WTO having a value of 10095 (WTO=10095) is programmed in the 0^{th} page P0 of the first memory block 152 together, and when the 10096^{th} write data is programmed in the 0^{th} page P0 of the second memory block 154, write order information WTO having a value of 10096 (WTO=10096) is programmed in the 0^{th} page P0 of the second memory block 154. When the 10097^{th} write data is programmed in the first page P1 of the first memory block 152, write order information WTO having a value of 10097 (WTO=10097) is programmed in the first page P1 of the first memory block 152 together, and when the 10098^{th} write data is programmed in the first page P1 of the second memory block 154, write order information WTO having a value of 10098 (WTO=10098) is programmed in the first page P1 of the second memory block 154. When the 10099^{th} write data is programmed in the second page P2 of the first memory block 152, write order information WTO having a value of 10099 (WTO=10099) is programmed in the second page P2 of the first memory block 152 together, and when the 10100^{th} write data is programmed in the third page P3 of the first memory block 152, write order information WTO having a value of 10100 (WTO=10100) is programmed in the third page P3 of the first memory block 152.

The write order information WTO is information that represents the order according to which write data are connected when the write data has a value greater than the value of one page and the write data are consecutively programmed in a plurality of pages. For example, in the case of the exemplified write data (not shown), the write data are sequentially programmed in six pages, which are the 0^{th} page P0 of the first memory block 152, the 0^{th} page P0 of the second memory block 154, the first page P1 of the first memory block 152, the first page P1 of the second memory block 154, the second page of the first memory block 152, and the third page P3 of the first memory block 152.

As described above, the controller 130 in accordance with the second embodiment of the present invention may program the write order information WTO together, when it programs write data (not shown) in the pages P0 to P3 that are included in each of the first memory block 152 and the second memory block 154. While the controller 130 performs the program operation, a sudden power-off (SPO) in which power supply to the memory system 110 is cut off abruptly may occur in the middle of the program operation.

When such sudden power-off occurs while write data (not shown) are being programmed there is no way of figuring out to what page the write data were normally programmed and what page was being programmed when the sudden power-off occurred. In short, a write error may occur.

Therefore, when the sudden power-off occurs and then the power supply is resumed, the controller 130 may enter a recovery operation section and search for the pages in which the program operation is normally finished.

Herein, although it is important to check out whether the write data are normally programmed in the pages P0 to P3 of each of the multiple memory blocks 152, 154, 156 and 159, it is also important to figure out whether the normally programmed write data are in an available state or not.

For example, when it is assumed that there are write data that has to be consecutively programmed in 6 pages and the write data are not normally programmed in the page of the fourth order among the 6 consecutive pages and the write pages are normally programmed in the pages of the first to third orders and the pages of the fifth to sixth orders, the write data that are programmed in the pages of the fifth to sixth orders following the erroneous page of the fourth order become meaningless data due to the write error occurring in the page of the fourth order. Therefore, if the write data are the data that are programmed in 6 consecutive pages, it is necessary to detect in what page the write error occurs.

The write order information WTO is information that represents the continuity of the write data (not shown). The write order information WTO has no relation with the order of the write operation. In other words, a write order information WTO having an early number does not signify that the write operation is performed and finished early. Therefore, after the sudden power-off, even though a particular write data which has a high number of write order information WTO is normally programmed this does not mean that other write data having write order informations WTO of lower numbers are all programmed normally, and the exemplary case described above where the write data are not normally programmed in the page of the fourth order among the 6 consecutive pages and the write pages are normally programmed in the pages of the first to third orders and the pages of the fifth to sixth orders may occur.

Therefore, the controller 130 in accordance with the second embodiment of the present invention may detect the recovery target page among the pages P0 to P3 that are included in each of the memory blocks 152, 154, 156 and 159 by performing the following operation in the recovery operation section.

First of all, the controller 130 may check out whether there are two or more open blocks among the memory blocks 152, 154, 156 and 159 that are included in the non-volatile memory device 150. In other words, the controller 130 may check out whether the write operation is being performed simultaneously in two or more memory blocks among the memory blocks 152, 154, 156 and 159 that are included in the non-volatile memory device 150 at a moment when the sudden power-off occurs. Herein, among the memory blocks 152, 154, 156 and 159 that are included in the non-volatile memory device 150, since the closed blocks may not be the target for the write operation at the moment when the sudden power-off occurs, the presence of the closed blocks is out of consideration in the recovery operation section.

For example, in FIG. 6, the first memory block 152 and the second memory block 154 are open blocks and the third block 156 is a closed block among the memory blocks 152, 154, 156 and 159 that are included in the non-volatile memory device 150.

As a result of checking the states of the memory blocks 152, 154, 156 and 159 that are included in the non-volatile memory device 150 in the recovery operation section, the first memory block 152 and the second memory block 154 are open blocks. Since there are two or more open blocks, the controller 130 may generate an order table 600 where the physical page numbers PPN of the pages P0 to P3 of each of the open blocks 152 and 154 are arrayed based on the write order informations WTO stored in the pages P0 to P3 of each of the open blocks 152 and 154. Herein, since the third memory block 156 and the i^{th} memory block 159 are closed blocks, the third memory block 156 and the i^{th} memory block 159 may not affect the generation of the order table 600. Also, the controller 130 may generate the order table 600 and store and manage the order table 600 in the volatile memory device 144 inside the controller 130.

To be specific, the controller 130 may read the write order informations WTO stored in the pages P0 to P3 that are included in each of the open blocks 152 and 154 once in the recovery operation section. For example, the value of the write order information WTO is confirmed to be 10095 by reading the 0^{th} page P0 of the first memory block 152; the value of the write order information WTO is confirmed to be 10097 by reading the first page P1 of the first memory block 152; the value of the write order information WTO is confirmed to be 10099 by reading the second page P2 of the first memory block 152; the value of the write order information WTO is confirmed to be 10100 by reading the third page P3 of the first memory block 152; the value of the write order information WTO is confirmed to be 10096 by reading the 0th page P0 of the second memory block 154; an erroneous state is detected that the write order information WTO is not normally stored by reading the first page P1 of the second memory block 154; and it is confirmed that the second and third pages P2 and P3 of the second memory block 154 are empty pages. Herein, it is assumed that all the pages P0 to P3 of each of the first memory block 152 and the second memory block 154 are in the valid state, and if there is an invalid-state page, the invalid page will be excluded from the targets for the read operation.

As described above, the controller 130 may read the write order informations WTO that are stored in the pages P0 to P3 of the open blocks 152 and 154 once, and store the physical page number PPN of each of the pages P0 to P3 of each of the open blocks 152 and 154 corresponding to the read write order information WTO in the order table 600 in the value order of the write order information WTO.

Herein, the controller 130 may store the physical page number PPN/logical page number LPN of each of the pages P0 to P3 of each of the open blocks 152 and 154 in the order table 600 according to the write order information WTO that is in the normal state among the read write order information WTO. Also, the controller 130 may maintain the space of the order table 600 corresponding to the write order information WTO that is in an erroneous state among the read write order informations WTO to be empty space EMPTY.

For example, when the physical page numbers PPN/logical page numbers LPN of the pages P0 to P3 of each of the open blocks 152 and 154 corresponding to the write order informations WTO that are read from the pages P0 to P3 of each of the first memory block 152 and the second memory block 154 are arrayed in the value order of the write order information WTO, the order becomes 4/75→0/76→5/77→EMPTY→6/79→7/80.

To be specific, when it is assumed that the controller 130 reads the pages P0 to P3 of the first memory block 152 first and then reads the pages P0 to P3 of the second memory block 154, the order of the read write order informations WTO becomes 10095→10097→10099→10100→10096→erroneous state.

Therefore, the controller 130 may store ‘4’, which is the physical page number PPN of the 0^{th} page P0 of the first memory block 152 corresponding to the write order information WTO having the value of 10095, which is read firstly, in the first space of the order table 600.

Subsequently, the controller 130 may store ‘5’, which is the physical page number PPN of the first page P1 of the first memory block 152 corresponding to the write order information WTO having the value of 10097, which is read secondly, in the third space of the order table 600. Also, the controller 130 may store the logical page number LPN having a value of 77 corresponding to the physical page numbers PPN having the value of ‘5’ in the third space of the order table 600 together. At this point, since the write order information WTO having the firstly read value of 10095 and the write order information WTO having the secondly read value of 10097 are not consecutive values and there is just not a write order information WTO having a value (which is 10096) between the two values, the controller 130 may store ‘4/75’, which is the physical page number PPN/logical page number LPN corresponding to the write order information WTO having the value of 10095, which is read firstly, in the first space of the order table 600, and then store ‘5/77’, which is the physical page number PPN/logical page number LPN corresponding to the write order information WTO having the value of 10097, which is read secondly, in the third space of the order table 600, while maintaining the second space of the order table 600 to be empty space.

Subsequently, the controller 130 may store ‘6’, which is the physical page number PPN of the second page P2 of the first memory block 152 corresponding to the write order information WTO having the value of 10099, which is read thirdly, in the fifth space of the order table 600. Also, the controller 130 may store the logical page number LPN having a value of 79 corresponding to the physical page numbers PPN having the value of ‘6’ in the fifth space of the order table 600 together. At this point, since the write order information WTO having the secondly read value of 10097 and the write order information WTO having the thirdly read value of 10099 are not consecutive values and there is just not a write order information WTO having a value (which is 10098) between the two values, the controller 130 may store ‘5/77’, which is the physical page number PPN/logical page number LPN corresponding to the write order information WTO having the value of 10097, which is read secondly, in the third space of the order table 600, and then store ‘6/79’, which is the physical page number PPN/logical page number LPN corresponding to the write order information WTO having the value of 10099, which is read thirdly, in the fifth space of the order table 600, while maintaining the fourth space of the order table 600 to be empty space.

Since it may be seen that the write order information WTO having the value of 10100, which is read fourthly, is a value connected to the write order information WTO having the value of 10099 corresponding to the fifth space of the order table 600, the controller 130 may store ‘7’, which is the physical page number PPN of the third page P3 of the first memory block 152 corresponding to the write order information WTO having the value of 10100 in the sixth space of the order table 600. Also, the controller 130 may store the logical page number LPN having a value of 80 corresponding to the physical page numbers PPN having the value of ‘7’ in the third space of the order table 600 together.

The controller 130 may store ‘0’, which is the physical page number PPN of the 0^{t}n page P0 of the second memory block 154 corresponding to the write order information WTO having the value of 10096, which is read fifthly, in the second space of the order table 600. Also, the controller 130 may store the logical page number LPN having a value of 76 corresponding to the physical page numbers PPN having the value of ‘0’ in the second space of the order table 600 together. At this point, since the write order information WTO having the fifthly read value of 10096 is a value connecting the write order information WTO having the value of 10095 corresponding to the first space of the order table 600 and the write order information WTO having the value of 10097 corresponding to the third space of the order table 600, the controller 130 may store ‘076’, which is the physical page number PPN/logical page number LPN corresponding to the write order information WTO having the value of 10096, which is read fifthly, in the second space of the order table 600.

Since it may be seen that the write order information WTO of the erroneous state is stored in the first page of the second memory block 154, which is read sixthly, the controller 130 may not store ‘1’, which is the physical page number PPN corresponding to the first page P1 of the second memory block 154, in the order table 600. Since the physical page numbers PPN having a value of ‘1’ is not stored in the order table 600, the controller 130 may not store the logical page number LPN corresponding to the physical page numbers PPN having a value of ‘1’ in the order table 600. Herein, since the second and third pages P2 and P3 of the second memory block 154 are empty space EMPTY, they are not read.

As described above, the controller 130 may read the pages P0 to P3 of the first memory block 152 first, and then read the write order informations WTO of the page s P0 to P3 of the second memory block 154 all in one time. Then, the physical page numbers PPN of the pages P0 to P3 of each of the open blocks 152 and 154 corresponding to the read write order informations WTO may be arrayed in the value order of the write order information WTO and stored in the order table 600, which is 4/75→0/76→5/77→empty space EMPTY→6/79→7/80.

Herein, the logical page numbers LPN corresponding to the physical page numbers PPN of the pages P0 to P3 included in each of the first memory block 152 and the second memory block 154 may be known by referring to the map information stored in the i^{th} memory block 159. Also, the map information stored in the i^{th} memory block 159 may be used for the generation of the order table 600 by being referred to after being copied into the volatile memory device 144 of the controller 130.

To take another example, when it is assumed that the controller 130 reads the pages included in the second memory block 154 and then reads the pages P0 to P3 included in the first memory block 152, the order of the read write order information WTO is 10096→erroneous state→10095→10097→10099→10100.

Therefore, the controller 130 may store ‘0’, which is the physical page number PPN of the 0^{th} page P0 of the second memory block 154 corresponding to the write order information WTO having the value of 10096, which is read firstly, in the first space of the order table 600. Also, the controller 130 may store the logical page number LPN having a value of 76 corresponding to the physical page numbers PPN having the value of ‘0’ in the first space of the order table 600 together.

Since it may be seen that the write order information WTO of the erroneous state is stored in the first page P1 of the second memory block 154, which is read secondly, the controller 130 may not store ‘1’, which is the physical page number PPN corresponding to the first page P1 of the second memory block 154, in the order table 600. Since the physical page number PPN having the value of ‘1’ is not stored in the order table 600, the controller 130 may not store the logical page number LPN corresponding to the physical page number PPN having the value of ‘1’ in the order table 600, either. Herein, since the second and third pages P2 and P3 of the second memory block 154 are empty space EMPTY, they are not read.

The controller 130 may figure out that the write order information WTO having the value of 10095, which is read thirdly, is smaller than the write order information WTO having the value of 10096 which corresponds to the first space of the order table 600 by being read first previously. Therefore, the controller 130 may move the storing space of ‘0/76’, which is the physical page number PPN/logical page number LPN corresponding to the write order information WTO having the value of 10096, which is read firstly, from the first space of the order table 600 to the second space of the order table 600, and store the ‘0/76’ in the second space of the order table 600. The controller 130 then may store ‘4’, which is the s7 physical page number PPN of the 0^{th} page P0 of the first memory block 152 corresponding to the write order information WTO having the value of 10095, which is read thirdly, in the first space of the order table 600. Also, the controller 130 may store the logical page number LPN having a value of 75 corresponding to the physical page numbers PPN having the value of ‘4’ in the first space of the order table 600 together, corresponding to the storing of the physical page number PPN having the value of ‘4’ in the first space of the order table 600. In short, the physical page number PPN/logical page number LPN of ‘4/75’ is stored in the first space of the order table 600, and the physical page number PPN/logical page number LPN of ‘0/76’ is stored in the second space of the order table 600.

Since it may be seen that the write order information WTO having the value of 10097, which is read fourthly, is a value connected to the write order information WTO having the value of 10096 corresponding to the second space of the order table 600, the controller 130 may store ‘5’, which is the physical page number PPN of the first page P1 of the first memory block 152 corresponding to the write order information WTO having the value of 10097 in the third space of the order table 600.

The controller 130 may store ‘6’, which is the physical page number PPN of the second page P2 of the first memory block 152 corresponding to the write order information WTO having the value of 10099, which is read fifthly, in the fifth space of the order table 600. Also, the controller 130 may store the logical page number LPN having a value of 79 corresponding to the physical page numbers PPN having the value of ‘6’ in the fifth space of the order table 600 together. At this point, since the write order information WTO having the fourthly read value of 10097 and the write order information WTO having the fifthly read value of 10099 are not consecutive values and it is just that there is not a value between the two, which is the write order information WTO having a value of 10098. Therefore, the controller 130 may store ‘5/77’, which is the physical page number PPN/logical page number LPN corresponding to the write order information WTO having the value of 10097, which is read thirdly, in the third space of the order table 600, and then store ‘6/79’, which is the physical page number PPN/logical page number LPN corresponding to the write order information WTO having the value of 10099, which is read fifthly, in the fifth space of the order table 600 while maintaining the fourth space of the order table 600 to be empty space.

Since it may be seen that the write order information WTO having the value of 10100, which is read sixthly, is a value connected to the write order information WTO having the value of 10099 corresponding to the fifth space of the order table 600, the controller 130 may store ‘7’, which is the physical page number PPN of the third page P3 of the first memory block 152 corresponding to the write order information WTO having the value of 10100 in the sixth space of the order table 600.

As described above, the controller 130 may read the pages P0 to P3 of the second memory block 154 first, and then read the write order informations WTO of the page s P0 to P3 of the first memory block 152 all in one time. Then, the physical page number PPN/logical page number LPN of the pages P0 to P3 of each of the open blocks 152 and 154 corresponding to the read write order informations WTO may be arrayed in the value order of the write order information WTO and stored in the order table 600, which is 4/75→0/76→5/77→empty space EMPTY→6/79→7/80.

When the order table 600 is generated as described above, the controller 130 may find out and array the recovery target pages among the pages P0 to P3 of each of the open blocks 152 and 154 by referring to the order table 600.

To be specific, the controller 130 may check out the physical page number PPN/logical page number LPN stored in the order table 600 in the value order of the write order information WTO and search for the empty space EMPTY. Herein, since the physical page number PPN/logical page number LPN are stored in the order table 600 in the value order of the write order information WTO, the controller 130 may sequentially examine the order table 600 from the first space to the last space one by one to find out whether there is an empty space EMPTY or not. The controller 130 may decide the pages P0 to P3 of the open blocks 152 and 154 corresponding to the physical page numbers PPN that are checked out ahead of the empty space EMPTY of the order table 600 as recovery target pages. The controller 130 may decide the pages P0 to P3 of the open blocks 152 and 154 corresponding to the physical page numbers PPN that are checked out behind the empty space EMPTY of the order table 600 as invalid pages. Also, the controller 130 may update the map information on the logical page numbers LPN and the physical page numbers PPN for the pages P0 to P3 of the open blocks 152 and 154 by referring to the order table 600. In other words, the controller 130 may maintain the map information on the physical page numbers PPN and the logical page numbers LPN corresponding to the physical page numbers PPN of the pages that are decided as the recovery target pages among the pages P0 to P3 of the open blocks 152 and 154 in the valid state. Also, the controller 130 may invalidate or delete the map information on the physical page numbers PPN and the logical page numbers LPN corresponding to the physical page numbers PPN of the pages that are decided as invalid pages among the pages P0 to P3 of each of the open blocks 152 and 154.

For example, in the above example, the order of 4/75→0/76→5/77→empty space EMPTY→6/79→7/80 is stored in the order table 600. Therefore, the controller 130 may check out that ‘4’ is stored in the first space, and then check out that ‘0/76’ is stored in the second space, and subsequently check out that ‘5/77’ is stored in the third space, and then check out that the fourth space is an empty space EMPTY, and subsequently check out that ‘6/79’ is stored in the fifth space, and then check out that ‘7/80’ is stored in the sixth space.

As a result, the controller 130 may find out that the fourth space of the order table 600 is an empty space EMPTY. Therefore, the controller 130 may decide the physical page numbers PPN of the pages of the open blocks corresponding to 4, 0 and 5 (which include the 0^{th} page P0 of the first memory block 152, the 0^{th} page P0 of the second memory block 154, and the first page P1 of the second memory block 154), which are checked out ahead of the fourth space, which is found to be the empty space EMPTY, as recovery target pages. Also, the controller 130 may decide the physical page numbers PPN of the pages of the open blocks corresponding to 6 and 7 (which include the second and third pages P2 and P3 of the first memory block 152), which are checked out behind the fourth space, which is found to be the empty space EMPTY, as invalid pages.

Also, the controller 130 may maintain the map information values for the physical page numbers PPN and the logical page numbers LPN corresponding to the physical page numbers PPN of the 0^{th} page P0 of the first memory block 152, the 0^{th} page P0 of the second memory block 154, and the first page P1 of the first memory block 152 (which are 4/77, 0/76 and 5/77) that are decided as the recovery target pages, in the valid state continuously. Herein, maintaining the map information values in the valid state may mean that they are maintained in the valid state in the i^{th} memory block 159 inside the non-volatile memory device 150 storing the map informations and in an internal space 610 of the volatile memory device 144. Also, the controller 130 may invalidate or delete map information values (which are 6/79 and 7/80) corresponding to the physical page numbers PPN and the logical page numbers LPN corresponding to the physical page numbers PPN for the second and third pages P2 and P3 of the first memory block 152 that are decided as invalid target pages. Herein, invalidating or deleting the map informations may mean that the map informations are invalidated or deleted in or from the i^{th} memory block 159 inside the non-volatile memory device 150 storing the map informations and in or from an internal space 610 of the volatile memory device 144.

In the memory system 110 in accordance with the second embodiment of the present invention, described above, the order table 600 may be generated while the pages P0 to P3 included in each of the open blocks 152 and 154 of the memory device 150 are read once, and the recovery target pages may be decided among the pages P0 to P3 included in each of the open blocks 152 and 154 by referring to the generated order table 600. Therefore, it does not have to read a corresponding page by alternately accessing the open blocks 152 and 154 to decide the recovery target pages among the pages P0 to P3 included in each of the open blocks 152 and 154.

Meanwhile, in the second embodiment of the present invention described above, the method of reading the write order informations WTO stored in the pages P0 to P3 of the open blocks 152 and 154 included in the memory device 150 in one time, and performing an operation of deciding the value order of the read write order informations WTO by directly comparing the values of the read write order informations WTO with each other during the operation of storing the physical page numbers PPN of the pages P0 to P3 of the open blocks 152 and 154 corresponding to the read write order informations WTO in the order table 600 in the value order of the write order information WTO may be used. Also, the following method may be used.

In the first place, the controller 130 may read the write order information WTO stored in one page disposed in the physically uppermost part among the pages P0 to P3 included in each of the open blocks 152 and 154 of the memory device 150 and set up the write order information WTO of the smallest value as a basic value (not shown).

For example, the controller 130 may read the write order information WTO stored in the 0^{th} page P0 disposed in the physically uppermost part among the pages P0 to P3 included in the first memory block 152 so as to figure out the value of 10095, and read the write order information WTO stored in the 0^{th} page P0 disposed in the physically uppermost part among the pages P0 to P3 included in the second memory block 154 so as to figure out the value of 10096. Therefore, the controller 130 may figure out that 10095 is a smaller value between the two read values, which are 10095 and 10096 and thus, the controller 130 may set up the 10095 as the basic value.

After setting up the basic value, the controller 130 may store the physical page number PPN/logical page number LPN of the pages P0 to P3 included in each of the open blocks 152 and 154 corresponding to the write order informations WTO in the order table 600 in the value order of the remainders obtained by subtracting the basic value from the values of the write order informations WTO that are read from the pages P0 to P3 included in each of the open blocks 152 and 154 of the memory device 150.

For example, the controller 130 may set up the remainder to ‘0’ by subtracting the basic value, which is 10095, from the write order information WTO having the value of 10095 which is read from the 0^{th} page P0 of the first memory block 152; set up the remainder to ‘2’ by subtracting the basic value, which is 10095, from the write order information WTO having the value of 10097 which is read from the first page P1 of the first memory block 152; set up the remainder to ‘4’ by subtracting the basic value, which is 10095, from the write order information WTO having the value of 10099 which is read from the second page P2 of the first memory block 152; set up the remainder to ‘5’ by subtracting the basic value, which is 10095, from the write order information WTO having the value of 10100 which is read from the third page P3 of the first memory block 152; and set up the remainder to ‘1’ by subtracting the basic value, which is 10095, from the write order information WTO having the value of 10096 which is read from the 0^{th} page P0 of the second memory block 154. Herein, since only the write order information WTO of the erroneous state is read from the first page P1 of the second memory block 154, there is no remainder.

Since the remainders may be set up as above, the controller 130 may store the physical page number PPN/logical page number LPN of the pages P0 to P3 of each of the open blocks 152 and 154 corresponding to the write order information WTO in the order table 600 in the value order of the remainders. As a result, the physical page number PPN/logical page number LPN stored in the order table 600 may be arrayed in the order of 4/75→0/76→5/77→empty space EMPTY→6/79→7/80 as described in the above example. Since the operation process is already described above in detail, further description is not provided herein.

Herein, since the write order information WTO stored in one page disposed in the physically uppermost part is read among the pages P0 to P3 that are included in each of the open blocks 152 and 154 in the process of deciding the basic value described above, it does not have to read one page disposed in the physically uppermost part among the pages P0 to P3 included in each of the open blocks 152 and 154 in the process of deciding the remainders. For example, since the 0^{th} page P0 of the first memory block 152 and the 0^{th} page P0 of the second memory block 154 are read in the process of deciding the basic value, the 0^{th} page P0 of the first memory block 152 and the 0^{th} page P0 of the second memory block 154 are not read in the process of deciding the remainders and only the first to third pages P<1:3> of the first memory block 152 and the first page P1 of the second memory block 154 are read.

Also, in the above-described process of deciding the basic value, the reason why the write order information WTO stored in one page disposed in the physically uppermost part among the pages P0 to P3 included in each of the open blocks 152 and 154 in the process of deciding the basic value described above is that it is a general program operation to perform a write operation in a page disposed in the physically upper part and then perform the write operation in a page disposed in the physically lower part. In other words, in one block, the value of the write order information WTO stored in a valid page disposed in the physically uppermost part of the block is generally the smallest value among the values of the write order informations WTO stored in all valid pages included in the block.

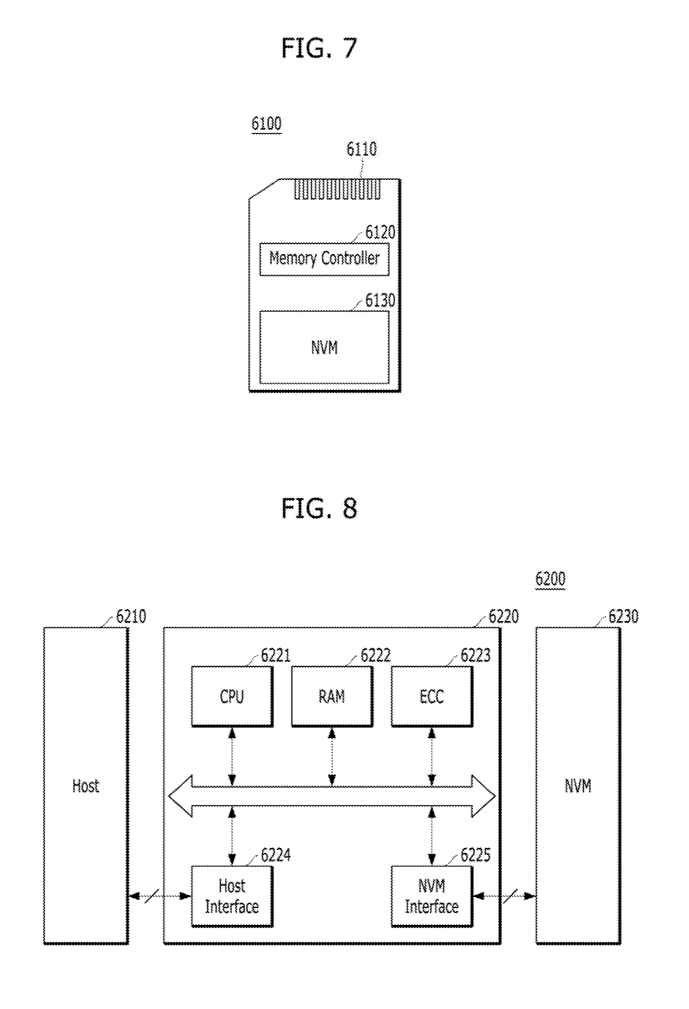

FIGS. 7 to 15 are diagrams schematically illustrating application examples of the data processing system of FIG. 1.

FIG. 7 is a diagram schematically illustrating another example of the data processing system including the memory system in accordance with the present embodiment, FIG. 7 schematically illustrates a memory card system to which the memory system in accordance with the present embodiment is applied.

Referring to FIG. 7, the memory card system 6100 may include a memory controller 6120, a memory device 6130 and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIGS. 1 and 5, and the memory device 6130 may correspond to the memory device 150 of the memory system 110 described with reference to FIGS. 1 and 5.

Thus, the memory controller 6120 may include a RAM, a processing unit, a host interface, a memory interface and an error correction unit. The memory controller 130 may further include the elements shown in FIG. 5.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 5.

The memory card may be, for example, a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 8 is a diagram schematically illustrating another example of the data processing system including the memory system in accordance with the present embodiment.

Referring to FIG. 8, the data processing system 6200 may include a memory device 6230 having one or more nonvolatile memories and a memory controller 6220 for controlling the memory device 6230. The data processing system 6200 illustrated in FIG. 8 may serve as a storage medium such as a memory card (CF, SD, micro-SD or the like) or USB device, as described with reference to FIG. 1. The memory device 6230 may correspond to the memory device 150 in the memory system 110 illustrated in FIGS. 1 and 5, and the memory controller 6220 may correspond to the controller 130 in the memory system 110 illustrated in FIGS. 1 and 5.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with the present embodiment may be applied to wired/wireless electronic devices or particularly a mobile electronic device.

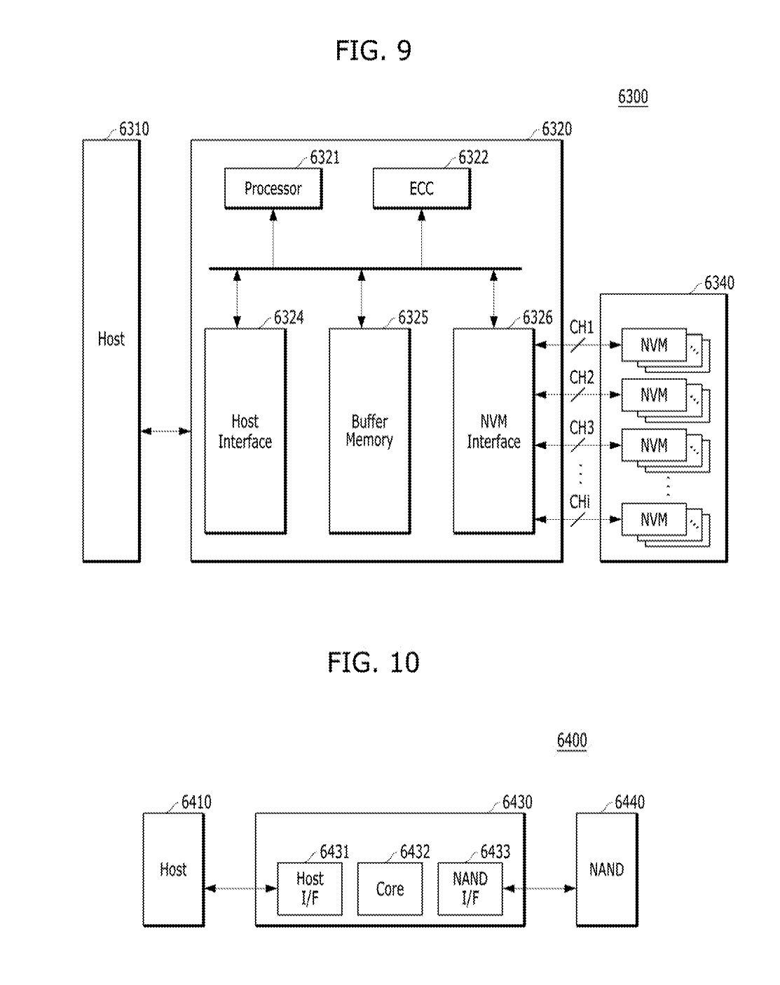

FIG. 9 is a diagram schematically illustrating another example of the data processing system including the memory system in accordance with the present embodiment. FIG. 9 schematically illustrates an SSD to which the memory system in accordance with the present embodiment is applied.

Referring to FIG. 9, the SSD 6300 may include a controller 6320 and a memory device 6340 including a plurality of nonvolatile memories. The controller 6320 may correspond to the controller 130 in the memory system 110 of FIGS. 1 and 5, and the memory device 6340 may correspond to the memory device 150 in the memory system of FIGS. 1 and 5.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 8 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIGS. 1 and 5 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 10 is a diagram schematically illustrating another example of the data processing system including the memory system in accordance with the present embodiment. FIG. 10 schematically illustrates an embedded Multi-Media Card (eMMC) to which the memory system in accordance with the present embodiment is applied.

Referring to FIG. 10, the eMMC 6400 may include a controller 6430 and a memory device 6440 embodied by one or more NAND flash memories. The controller 6430 may correspond to the controller 130 in the memory system 110 of FIGS. 1 and 5, and the memory device 6440 may correspond to the memory device 150 in the memory system 110 of FIGS. 1 and 5.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

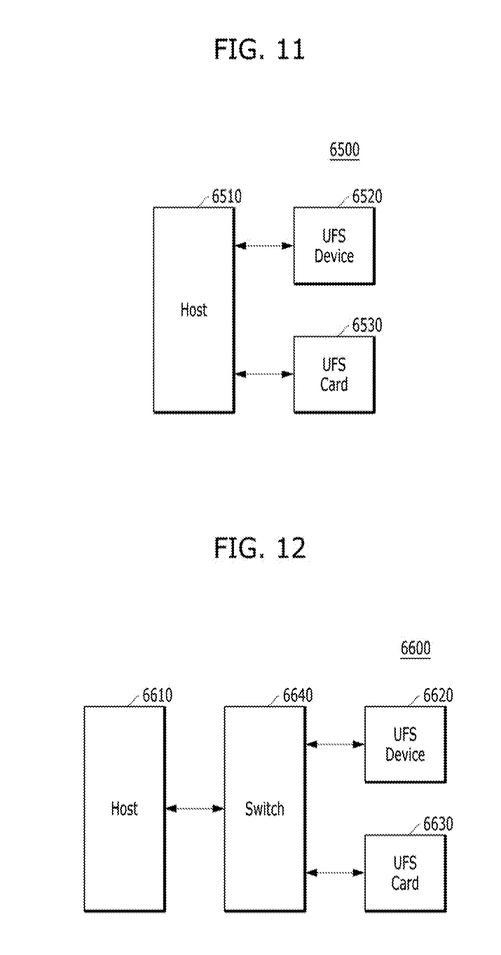

FIGS. 11 to 14 are diagrams schematically illustrating other examples of the data processing system including the memory system in accordance with the present embodiment. FIGS. 11 to 14 schematically illustrate UFS (Universal Flash Storage) systems to which the memory system in accordance with the present embodiment is applied.

Referring to FIGS. 11 to 14, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIGS. 1 and 5. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 8 to 10, and the UFS cards 6530, 6630, 6730 and 6830 may be embodied in the form of the memory card system 6100 described with reference to FIG. 7.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 11, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 12, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

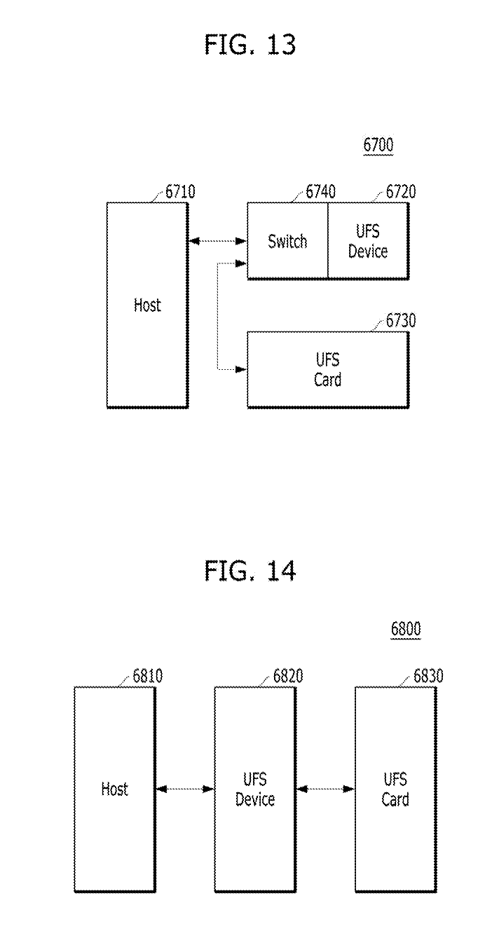

In the UFS system 6700 illustrated in FIG. 13, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 14, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

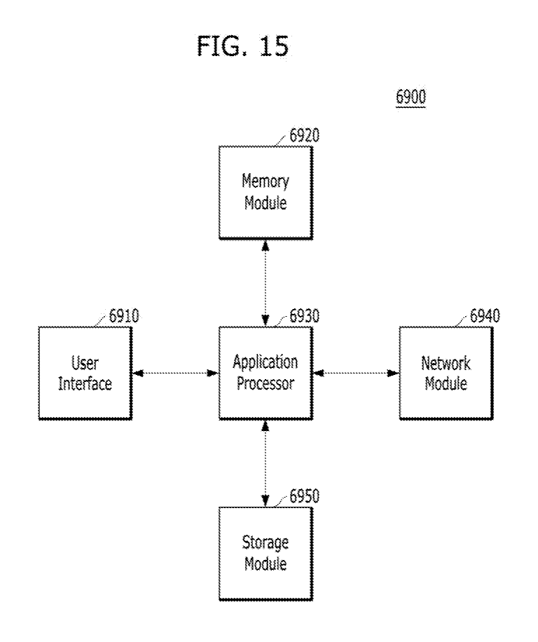

FIG. 15 is a diagram schematically illustrating another example of the data processing system including the memory system in accordance with an embodiment. FIG. 15 is a diagram schematically illustrating a user system to which the memory system in accordance with the present embodiment is applied.

Referring to FIG. 15, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIGS. 1 and 5. Furthermore, the storage module 6950 may be embodied as an SSD, eMMC and UFS as described above with reference to FIGS. 9 to 14.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIGS. 1 and 5 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

The memory system, according to embodiments of the present invention, may, after a sudden power-off occurs, read the pages of the open blocks only once in a recovering operation period in which the power is re-supplied for generating an order table in which the states of the pages of the open blocks are sorted and referring to the table, the page to be restored among the pages of the open blocks may be identified. Therefore, it is possible to minimize the number of times the open blocks are read for determining the recovery target page.

While the present invention has been described with respect to specific embodiments, it will be apparent to those skilled in the art that various changes and modifications may be made without departing from the spirit and scope of the invention as defined in the following claims.

What is claimed is:

1. A memory system comprising:
a non-volatile memory device that includes a plurality of memory blocks each of which includes a plurality of pages; and
a controller suitable for programming write data together with corresponding write order information in the plurality of the pages during a write operation,
wherein when two or more open blocks are detected among the plurality of the memory blocks during a recovery operation, the controller generates an order table where physical page numbers of the pages of the open blocks are arrayed based on the write order information and determines at least one recovery target page among pages of the open blocks based on the order table.

2. The memory system of claim 1, wherein the write order information includes values representing a write sequence of the write data programmed in the respective pages, and wherein the controller generates the order table by reading the write order information stored in the pages of the open blocks on a block-by-block basis, and stores in the order table the physical page numbers of the pages of the open blocks according to an ascending value order of the write order information.

3. The memory system of claim 2, wherein the controller generates the order table by storing in the order table the physical page numbers of the pages of the open blocks corresponding to the write order information that are in a normal state, and maintains empty a space for the physical page number of the page of the open blocks corresponding to the write order information that are in an erroneous state.

4. The memory system of claim 3, wherein the controller determines as the at least one recovery target page one or more pages corresponding to the physical page numbers located ahead of the empty space in the order table.

5. The memory system of claim 4, wherein the controller further determines as invalid pages one or more pages corresponding to the physical page numbers located behind the empty space in the order table.

6. The memory system of claim 5, wherein the controller generates the order table by storing in the order table logical page numbers corresponding to the physical page numbers to be stored in the order table.

7. The memory system of claim 6, wherein the controller updates map information on the logical page numbers and the physical page numbers based on the order table.

8. The memory system of claim 7, wherein the controller maintains valid the map information on the physical page numbers and corresponding logical page numbers of the recovery target pages, and invalidates or deletes the map information on the physical page numbers and corresponding logical page numbers of the invalid pages.

9. The memory system of claim 2, wherein the controller reads first an open block having a page storing the write order information of a smallest value among the open blocks, and arranges the physical page numbers according to the ascending value order of the write order information when storing the physical page numbers in the order table.

10. The memory system of claim 1, wherein the controller performs the recovery operation when a power is resumed after a sudden power-off of the memory system.

11. A method for operating a memory system provided with a non-volatile memory device including a plurality of memory blocks each of which includes a plurality of pages, the method comprising:
programming write data together with corresponding write order information in the plurality of the pages during a write operation; and
when two or more open blocks are detected among the plurality of the memory blocks during a recovery operation, generating an order table where physical page numbers of the pages of the open blocks are arrayed according to the write order information and determining at least one recovery target page among pages of the open blocks based on the order table,
wherein the write order information includes values representing a write sequence of pieces of the write data programmed in the respective pages.

12. The method of claim 11, wherein the generating of the order table includes:
reading the write order information stored in the pages of the open blocks on a block-by-block basis; and
storing in the order table the physical page numbers of the pages of the open blocks according to an ascending value order of the write order information.

13. The method of claim 12, wherein the generating of the order table includes:
storing in the order table the physical page numbers of the pages of the open blocks corresponding to the write order information that are in a normal state; and
maintaining empty a space for the physical page number of the page of the open blocks corresponding to the write order information that are in an erroneous state.

14. The method of claim 13, wherein the determining includes determining as the at least one recovery target page one or more pages corresponding to the physical page numbers located ahead of the empty space in the order table.

15. The method of claim 14, wherein the determining further includes determining as invalid pages one or more pages corresponding to the physical page numbers located behind the empty space in the order table.

16. The method of claim 15, wherein the generating of the order table includes storing in the order table logical page numbers corresponding to the physical page numbers to be stored in the order table.

17. The method of claim 16, further comprising updating map information on the logical page numbers and the physical page numbers based on the order table.

18. The method of claim 17, wherein the updating of the map information includes:
maintaining valid the map information on the physical page numbers and corresponding logical page numbers of the recovery target pages; and
invalidating or deleting the map information on the physical page numbers and corresponding logical page numbers of the invalid pages.

19. The method of claim 12, wherein the reading of the write order information includes:
reading first an open block having a page storing the write order information of a smallest value among the open blocks; and
arranging the physical page numbers according to the ascending value order of the write order information when storing the physical page numbers in the order table.

20. The method of claim 11, further comprising performing the recovery operation when a power is resumed after a sudden power-off of the memory system.
